(19) United States
(12) Patent Application Publication
(10) Pub. No.: US 2014/0124995 A1
(43) Pub. Date: May 8, 2014

(54) Bearing Unit for Commercial Vehicles

(71) Applicant: Rolf Spielmann, Wertheim (DE)

(72) Inventor: Rolf Spielmann, Wertheim (DE)

(73) Assignee: SAF-HOLLAND GmbH

(21) Appl. No.: 14/125,807

(22) PCT Filed: Jul. 9, 2012
(86) PCT No.: PCT/EP2012/063357

§ 371 Date: Dec. 12, 2013

(30) Foreign Application Priority Data
Jul. 14, 2011 (DE) 10 2011 079 163.9

(51) Int. Cl. B60G 11/24; F16F 1/38

(52) U.S. Cl. CPC B60G 11/24; F16F 1/3807
USPC 267/292

(57) ABSTRACT

A bearing unit for axle systems includes a holding element, a sleeve element and a bearing element, wherein the holding element has a first engagement region which is designed in order substantially to enclose the bearing element in one plane, wherein the bearing element has a first recess which is directed transversely with respect to the plane and in which the sleeve element is arranged, wherein the sleeve element is mounted resiliently in the plane relative to the holding element via the bearing element, wherein the holding element has a second engagement region in which a fixing element engages in order to fix the first engagement region frictionally on the bearing element, and wherein at least one of the first fastening region and the bearing element has a non-circular shape such that a rotational movement of the bearing element relative to the holding element is prevented.

### BACKGROUND OF THE INVENTION

The present invention relates to a bearing unit, in particular for axle systems of commercial vehicles according to the preamble of claim 1.

Certain bearing units have been used in commercial vehicles. Here, in particular the trailing arm of the axle suspension system of a commercial vehicle is fixed to the vehicle frame by means of an elastically deformable bearing element. Up to now, elastic bearing elements have been pressed into so-called bearing eyes on the trailing arm, wherein such great forces are required that the use of a tool, for example a hydraulically operated tool, is required. Furthermore, when great forces are applied to the bearing element, there is the danger that the elastically deformable material of the bearing element is damaged. In the case of circular bearing eyes with bearing elements pressed into them, there is also the problem that the bearing eye and the bearing element might rotate relative to one another. This might lead to damage to the bearing element due to excessive heat and increased wear due to abrasion.

Thus, the object underlying the present invention is to provide a bearing unit, in particular for axle systems of commercial vehicles, which may be easily manufactured and mounted and which avoids overheating of or abrasive wear on the bearing element.

### SUMMARY OF THE INVENTION

According to the invention, the bearing unit comprises a holding element, a sleeve element and a bearing element, wherein the holding element has a first engagement region, which is designed in order to substantially enclose the bearing element in one plane E, wherein the bearing element has a first recess, which is directed transversely with respect to the plane E and in which the sleeve element is arranged, wherein the sleeve element is mounted resiliently in the plane E relative to the holding element via the bearing element, wherein the holding element has a second engagement region, in which a fixing element engages, in order to fix the first engagement region frictionally on the bearing element, and wherein the first fastening region, respectively the first engagement region, and/or the bearing element have/has a non-circular shape such that a rotational movement of the bearing element relative to the holding element is prevented. Preferably, the holding element may be the fastening region or a fastening region of the trailing arm of the axle suspension system of the commercial vehicle. The holding element has a first engagement region, which preferably is designed such that a bearing element may be arranged and fixed in the first engagement region. The first engagement region preferably forms a bearing eye and preferably may be brought both into a mounting state and into an operative state. The mounting state is characterized in that the first engagement region is widened such that the bearing element may be inserted in the space enclosed by the first engagement region without requiring a deformation or squeeze of the bearing element. From the mounting state, also the first engagement region may be brought into the operative state by an elastic deformation of the holding element, wherein the bearing element arranged in the first engagement region is friction-locked on the first engagement region. To put it differently, the cross-section of the space enclosed by the first engagement region along the plane E is decreased such that the first engagement region presses onto the bearing element so that a frictional connection is provided between the first engagement region and the bearing element. In order to bring the first engagement region from the mounting state into the operative state, the holding element comprises a second engagement region, which is operatively connected to the first engagement region, in order to preferably exert a force onto the first engagement region, which elastically deforms the first engagement region. The force transmitted from the second engagement region to the first engagement region applies a fixing element to the second engagement region. Preferably, the fixing element is a bolt-nut connection, which may apply a tensile force, which is transmitted via the second engagement region to the first engagement region, and deforms the first engagement region such that its cross-section or the cross-section of the space enclosed by the first engagement region in the plane E decreases. According to the invention, the bearing element comprises a first recess, which is directed transversely relative to the plane E, in which a sleeve element is arranged. Preferably, the sleeve element is a bush, particularly preferably made from a metal material, and comprises a recess serving to accommodate a preferred bearing journal or pin, wherein the pin or journal secures the sleeve element against displacement in the plane E relative to the vehicle frame of the commercial vehicle. According to the invention, the first engagement region and/or the bearing element has/have a non-circular shape so that a rotational movement of the bearing element relative to the holding element is prevented. The non-circular shape preferably is the shape of the cross-section in the plane E of the bearing element and of the space enclosed by the first engagement region. It is further preferred that the non-circular shape is present in the operative state, i.e. in the state in which the first engagement region is fixed to the bearing element, wherein the first fastening region or the bearing element may have a non-circular shape or a non-circular cross-section already before mounting, i.e. in the mounting state. The non-circular shape mainly serves to prevent a rotational movement of the bearing element relative to the holding element or relative to the first fastening region of the holding element, in particular in order to avoid or reduce excess wear on the bearing element, by abrasion, for example.

In a preferred embodiment, the first recess on the bearing element is designed such that the spring characteristics of the bearing element depends on the direction in the plane. Spring characteristics in general is defined as the relationship between the force applied to the spring or the elastic material and the resultant path length of the deformation of the elastic material. Here, the spring characteristics is all the more steeper the greater the force required for achieving a particular deformation of the spring material. In the case of the present invention, it may for example be preferred that the bearing element in the vertical direction has spring properties which differ from the spring properties in the horizontal direction, wherein for achieving said different spring properties or the different spring characteristics of the bearing element in different directions, the material strength of the elastic material in the plane E, departing from the first recess of the bearing element, may adopt different values in different directions. To put it differently, the recess or the first recess of the bearing element is preferably arranged eccentrically, wherein a force transmitted to the sleeve element in respective different directions along the plane E causes varying degrees of deformation of the bearing element and, thus, the sleeve element is differently sprung or deflected in different directions along the plane E. Preferably, apart from a region in which the sleeve element is supported, the first recess of the bearing element may also comprise further regions in the directions of which the spring characteristics of the bearing element is less steep or in which the bearing element has a softer spring property. To put it differently, a local weakening of the material of the bearing element or a reduction of the cross-section, which is perpendicular to the force to be cushioned or absorbed, will influence the spring properties of the bearing element such that a longer spring travel is achieved with the same spring force and, thus, there is provided a softer spring property of the bearing element. Thus, the first recess of the bearing element may have lamellae-like portions, for example, wherein the bearing element in particular transversely to the lamellae has a softer spring property than transversely to a comparable spring element, which is designed as a solid body.

It may be advantageous for the bearing element to have second recesses and/or cavities in order to make the spring characteristics of the bearing element in the form of the first recess in the direction running to the second recess/cavity less steep than in the direction running transversely thereto. In addition to the first recess, in which the sleeve element is arranged, it may thus be preferred to add second recesses or cavities in the bearing element. Said recesses and/or cavities cause a respective cross-sectional narrowing of the cross-section of the bearing element, wherein applying a force to the bearing element will achieve a larger spring travel than applying the same force to the bearing element without a second recess would achieve. This effect is due to the fact that narrowing the cross-section while applying the same force causes greater stresses in the narrowed cross-section than in a comparatively larger cross-section, wherein with the same material parameters the bearing element with the small cross-section transversely to the direction of force is subjected to a greater deformation than the bearing element having the larger cross-section. By purposefully using second recesses in certain directions, departing from the first recess, it is possible to adjust a certain spring property or spring characteristics for the spring-loaded bearing of the sleeve element in the first recess of the bearing element. It is preferred that the spring characteristics is adjusted in particular for forces in the plane E, i.e. preferably in the plane which preferably lies transversely relative to the first recess.

It is further preferred that the bearing element is positively secured at the first engagement region of the holding element against displacement transverse to the plane E relative to the holding element. Since the first holding region encloses the bearing element in the plane E and there is also provided a frictional connection between the first engagement region and the bearing element in this plane, the bearing element is secured in the plane E or against displacement along the plane E relative to the first engagement region and, thus, relative to the holding element. In order to prevent a displacement of the bearing element transverse to the plane E relative to the first engagement region of the holding element, there is provided a positive connection of the first engagement region and the bearing element. It is in particular preferred that the first engagement region transverse to the plane E has undercuts, which secure the bearing element against displacement transverse to the plane E relative to the holding element.

It is in particular preferred that the bearing element at its outer surface directed transversely relative to the plane E has a ball-like shape, which at least over a certain area engages a concave shape of the first engagement region in a positively fitting manner. Here, it is preferred that the surface of the first engagement region facing the inside, i.e. towards the bearing element, is shaped concavely and engages the ball-like shape of the outer surface of the bearing element at least over a certain area. In this way, the bearing element is secured against displacement transverse to the plane E relative to the first engagement region of the holding element. As an alternative to the concave shape, the first engagement region may also have a rectangular shape or circular shape at its inside, wherein the bearing element at its outside has a respective shape which corresponds thereto at least over a certain area.

In a preferred embodiment, the mean radius of the bearing element parallel to the plane E to the mean radius of curvature of the ball-like shape of the bearing element transverse to the plane E is in a relationship of preferably 0.2 to 2, more preferably 0.5 to 1.7, and most preferably particularly about 0.9. Preferably, by choosing a certain relationship of the mean radius of the bearing element to the mean radius of curvature of the ball-like shape of the bearing element, there may be adjusted the height of the undercut, which secures the bearing element against displacement transverse to the plane E relative to the holding element. Mean radius of the bearing element designates the mean extension of the bearing element in the plane E in the case of a non-circular shape of the bearing element in the plane E. Mean radius of curvature of the ball-like shape of the bearing element designates a mean or average radius of curvature of said ball-like shape of the bearing element. If the relationship of the two radii relative to each other is increased, in the case of an invariant mean radius of the bearing element parallel to the plane E, the mean radius of curvature of the ball-like shape of the bearing element becomes smaller and, thus, the curvature of the ball-like shape of the bearing element more and more approximates a semi-circular shape. By increasing the radii relationship, there is preferably increased the length of overlap of the undercut of the engagement region of the holding element, which is preferably at least over a certain area congruent to the geometry of the ball-like shape. Alternatively preferably, the curvature of the ball-like shape of the bearing element may also be defined by a relationship of the radius of curvature to the thickness of the bearing element, i.e. to its extension transverse to the plane E, wherein the relationship of the radius of curvature of the bearing element to the thickness of the bearing element transverse to the plane E is preferably in the range from 0.5 to 2. Here, a relationship of 0.5 of the radius of the curvature of the bearing element to the thickness of the bearing element is always the minimum, in which the bearing element precisely has a semi-circular curvature.

It is advantageous for the bearing element to have a nose-shaped projection, which extends in the direction of the transition area between the first and second engagement regions of the holding element in order to secure the bearing element against rotational displacement in the plane E relative to the holding element. The nose-shaped projection of the bearing element preferably is an eccentric shaping of the bearing element, which projects into the region in which the first engagement region is held by the second engagement region against the bearing element and, due to the eccentric shape, prevents a rotation of the bearing element relative to the first engagement region of the holding element or relative to the holding element.

In a preferred embodiment, the bearing element is deformed by the force transmitted in the first engagement region such that the cross-section of the bearing element in the plane E is designed drop-shaped. Thus, a drop shape is preferred for a non-circular shape of the bearing element, wherein the pointed or tapered end of the drop shape preferably is the nose-shaped projection which secures the bearing element against rotation relative to the holding element in the plane E. The bearing element may both be deformed by the force transmitted from the first engagement region and have a drop-shaped form already before being mounted in the first engagement region.

In a further preferred embodiment, the first engagement region is elastically deformed by the force applied by the fixing element and transmitted from the second engagement region so that, when the fixing element is released, the first engagement region returns to a position in which the bearing element is not fixed to the holding element. Thus, it is preferred that, when the fixing unit is removed and thus the force, which acts onto the first engagement region in the plane E, is no longer applied, the first engagement region of the holding element returns to a position in which the bearing element is not fixed to the holding element. To put it differently, this means that the first engagement region of the holding element has a rest position, in which the space enclosed by it in the plane E is larger than the extension of the bearing element in the plane E so that the bearing element may be inserted into and removed again from the recess or the enclosed region of the first engagement region and, merely by applying a force which elastically deforms the first engagement region, the first engagement region is put into the operative state, in which it encloses the bearing element, and there is produced a frictional connection or a press-fit connection between the first engagement region and the bearing element. In the operative state, there is preferably provided a press-fit between the first engagement region of the holding element and the bearing element.

It is further preferred that the second recesses/cavities on the bearing element follow the path of a circle-segment shape running parallel to the plane E and concentrical to the first recess. To put it differently, preferably crescent-shaped recesses and/or cavities are introduced into the bearing element, wherein the center of the crescent-shaped or circle-segment-shaped path is arranged congruently with the center of the first recess of the bearing element. In the case of a non-circular design of the first recess of the bearing element, reference can preferably be made to the center of the central circular path or a central circular path of the first recess of the bearing element.

In a particularly preferred embodiment, the bearing element has at least two second recesses or cavities arranged at opposite sides of the first recess. With the help of two opposite second recesses or cavities, it is possible to adjust a spring characteristics in a first direction, which differs significantly from a second direction lying transversely to the first one, in which no second recesses or cavities intersect the course of the direction of force. Introducing second recesses may be preferred in particular when a spring characteristics is desired in the direction from the first to the second recess, which is to differ significantly from the direction lying transversely relative thereto, wherein a recess or a recess passing transverse to the plane E through the entire material of the bearing element represents the greatest material weakening. In particular, introducing second recesses may adjust a non-constant spring characteristics for the bearing element since at first, when deformation starts, the two opposite sides of the second recess are moved towards one another and finally rest one on top of the other, wherein from the moment when the two sides or flanks of the second recess lie on top of each other, when there is a further deformation, the spring characteristics takes a steeper course by leaps and bounds. Introducing second cavities—i.e. recesses or holes which do not extend or pass through the entire bearing element—at the bearing element may be preferred when a constant course of the spring characteristics of the bearing element is preferred, wherein the second cavities do not fully pass through the bearing element transverse to the plane E and, thus, there always remains a material bridge in the bearing element. It may be further preferred to provide a combination of second recesses and second cavities on the bearing element, wherein it is possible to adjust constant or non-constant spring characteristics for the bearing element in different directions.

In a preferred embodiment, the second engagement region of the holding element comprises two legs having an end which transitions into the first engagement region, wherein the fixing element displaces the legs towards each other and/or holds them in adjoining positions in order to deform the first engagement region such that it is frictionally fixed at the bearing element. The two legs of the second engagement region of the holding element serve to transmit the force applied by the fixing element onto the first engagement region of the holding element and to deform the latter such that it is frictionally fixed at the bearing element. It may be preferred that one of the two legs is a continuation of the first engagement region, which is angled and comprises a recess, and the second leg preferably is arranged between the first engagement region and a further continuation of the trailing arm and also comprises a recess. Preferably, the recesses of the legs are engaged by the fixing element, which particularly preferably is a bolt/screw. It is further preferred that the fixing element is a pin having a recess for a securing pin lying transversely to the main extension axis of the pin or a sleeve put over the legs when they are pressed together or lie on top of each other.

Further advantages and features result from the following description of a preferred embodiment of the bearing unit according to the invention with reference to the appended Figures. As a matter of course, features of individual embodiments of the preferred embodiment shown in the Figures may be combined with each other within the framework of the invention.

### BRIEF DESCRIPTION OF THE DRAWINGS

FIG. 1A-FIG. 1D are views of preferred embodiments of the bearing unit according to the invention; and

FIGS. 2A and 2B are sectional views of two preferred embodiments of the bearing unit according to the invention.

### DETAILED DESCRIPTION OF THE PREFERRED EMBODIMENTS

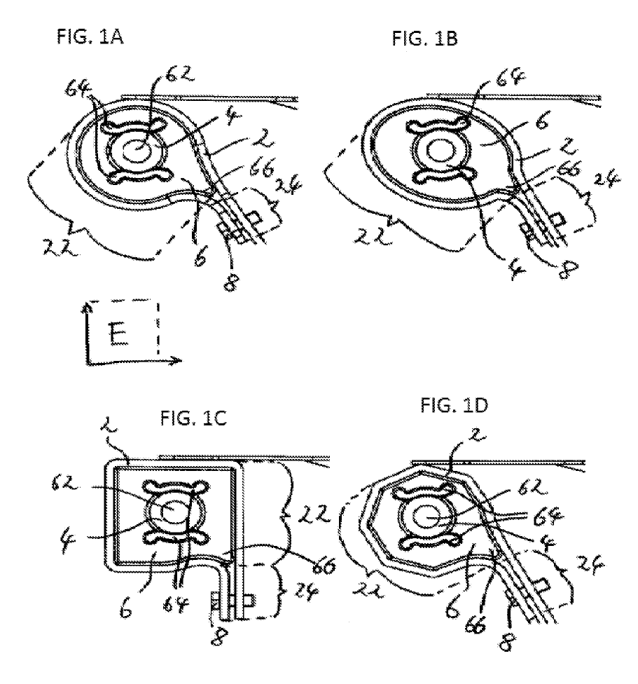

FIG. 1A-FIG. 1D are four side views, with a viewing direction perpendicular to the plane E, of preferred embodiments of the bearing unit according to the invention. In the four embodiments, the bearing unit comprises a holding element 2, a sleeve element 4, a bearing element 6, and a fixing element 8. In each of the embodiments shown, the holding element 2 comprises a first engagement region 22 and a second engagement region 24. The first engagement region 22 preferably is formed such that it encloses the bearing element 6 in the plane E. The second engagement region 24 preferably adjoins the two ends of the first engagement region 22 and preferably comprises a recess in which the fixing element 8 is accommodated. Preferably, the fixing element is a screw/bolt or a bolt-nut-connection and applies a force onto the second engagement region 24 which displaces the two legs of the second engagement region towards each other or keeps them pressed against one another. The force transmitted from the fixing element 8 onto the second engagement region 24 is preferably further transmitted to the first engagement region 22 and causes the latter to be pressed against the bearing element 6. The bearing element 6 is preferably frictionally fixed at the first engagement region 22 of the holding element 2. Furthermore, according to the invention, the bearing element 6 comprises a first recess 62 extending transversely relative to the plane E, in which the sleeve element 4 is arranged. Preferably, the sleeve element 4 is vulcanized into the recess of the bearing element 6, which preferably is made from rubber, or it is fixed in the first recess by means of a bonded connection. The sleeve element 4 is preferably designed tube-shaped or sleeve-shaped and comprises a recess, in which preferably a journal or pin may be arranged connecting the sleeve element to the vehicle frame and securing it against displacement along the plane E. Further preferably, the bearing element 6 has second recesses or cavities 64. By means of the said recesses or cavities it is preferably possible to adjust a spring characteristics of the bearing element 6 which is different in different directions in the plane E. In the embodiment of the second recesses 64 of the bearing element 6 shown in FIG. 1A-FIG. 1D, it is to be expected that the bearing element 6 it is more easily deflected in the vertical direction and that the spring characteristics is accordingly flat, while in the horizontal direction a harder cushioning of the sleeve element 4 relative to the first engagement region 22 has to be expected.

The embodiments shown in FIG. 1A-FIG. 1D essentially differ in the outer contour of the bearing element 6 and the forming of the first engagement region 22. In the embodiment shown in FIG. 1A, the bearing element 6 and the first engagement region 22 have a drop-like shape. In the embodiment shown in FIG. 1B, the bearing element 6 and the first engagement region 22 have an elliptic and also a drop-like shape, wherein the bearing element 6 was clearly made wider with regard to the dimensions of the first and second recesses 62, 64 so as to achieve a larger material thickness in the cross direction and, thus, changed spring characteristics compared to the drop shape in this direction. Furthermore, the cuboid embodiment of the bearing element 6 or of the first engagement region 22 of the holding element 2 shown in FIG. 1C, or the polygonal embodiment shown in FIG. 1D may be preferred. In particular, the four embodiments A-D shown are characterized in particular in that they secure the bearing element 6 against rotational displacement relative to the holding element 2 to a different degree, wherein the drop shape shown in FIG. 1A is less secured against rotation than the more eccentrically designed embodiments B and C. A common feature of all embodiments is the nose-shaped projection 66, which prevents a rotational movement of the bearing element 6 relative to the holding element 2 by resting against the inside of the first engagement region 22. The nose-shaped projection 66 of the bearing element 6 is preferably formed such that in the case of an assembled bearing unit it expediently extends in the direction of the fixing element. In particular, the nose-shaped projection 66 extends along the converging regions of the holding element 2 in the area of the first engagement region 22, wherein said converging regions transition into the second engagement region 24.

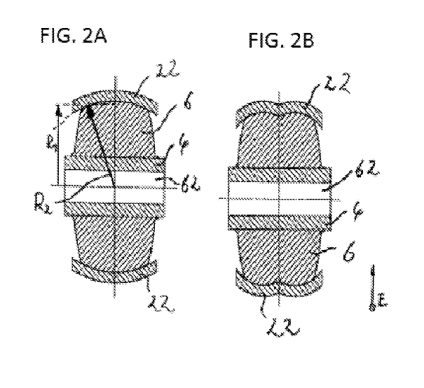

In the preferred embodiment shown in FIGS. 2A and 2B, the bearing element 6 has a ball-like shape at its outer surface. From the sectional view, there are clearly discernible the resultant convex edges of the bearing element 6 and in addition the inner surface of the first engagement region 22, which corresponds thereto at least over a certain area, which preferably has a concave edge in the sectional view. The inner surface of the first engagement region 22 transverse to the plane E forms at each side of the bearing element 6 a cutback. By means of said cutbacks the bearing element 6 is secured against sliding laterally out of the holding element 2 or the first engagement region 22, respectively. To put it differently, the bearing element 6 is positively fixed at the first engagement region 22 transversely relative to the plane E. The ball-shaped outer surface of the bearing element 6 has a radius of curvature R₂ which is designed in a relationship of preferably 0.2 to 2 to the mean radius R₁ of the bearing element 6. Particularly preferred is the relationship of R₁ to R₂ of about 0.5 to 1.7. As is shown in FIG. 2A, the bearing element 6 preferably has a single ball-like shape which engages a single convex shape of the first engagement region 22. Furthermore, as is shown in FIG. 2B, a double ball-like shaping of the bearing element 6, which cooperates with a double concave shape of the first engagement region 22, may be preferred.

### LIST OF REFERENCE SIGNS

2—holding element
4—sleeve element
6—bearing element
8—fixing element
22—first engagement region
24—second engagement region
62—first recess
64—second recess
66—nose-shaped projection
R₁—mean radius of the bearing element
R₂—mean radius of curvature

1-9. (canceled)

10. A bearing unit for an axle system of a commercial vehicle, comprising:
a holding element;
a sleeve element; and
a bearing element;
wherein the holding element has a first engagement region that substantially encloses the bearing element in one plane E;
wherein the bearing element has a first recess which is directed transversely with respect to the plane E and in which the sleeve element is arranged;
wherein the sleeve element is mounted resiliently in the plane E relative to the holding element via the bearing element;
wherein the holding element has a second engagement region in which a fixing element engages, in order to fix the first engagement region frictionally on the bearing element;
wherein at least one of the first engagement region and the bearing element has a non-circular shape so that a rotational movement of the bearing element relative to the holding element is prevented; and
wherein the bearing element has a nose-shaped projection extending in the direction of the transitional region between the first and second engagement regions of the holding element and secures the bearing element against rotation in the plane E relative to the holding element.

11. The bearing unit of claim 10, wherein the first recess in the bearing element is configured such that a spring characteristic of the bearing element is dependent on the direction in the plane.

12. The bearing unit of claim 11, wherein the bearing element has second recesses in order to make the spring characteristic of the bearing element in the direction running from the first recess towards the second recess less steep than in the direction running transversely thereto.

13. The bearing unit of claim 12, wherein the bearing element at the first engagement region of the holding element is positively secured against displacement transverse to the plane E, relative to the holding element.

14. The bearing unit of claim 13, wherein the bearing element is ball-shaped at a position outer surface located transversely relative to plane E, which at least over a certain area positively engages a concave shape of the first engagement region.

15. The bearing unit of claim 14, wherein the relationship of a mean radius R₁ of the bearing element parallel to the plane E to a mean radius of curvature R₂ of the ball-shaped outer surface of the bearing element transverse to the plane E is within the range of about 0.2 to about 2.

16. The bearing unit of claim 15, wherein the relationship of the mean radius R₁ of the bearing element parallel to the plane E to the mean radius of the curvature R₂ of the balls-shaped outer surface of the bearing element transverse to the plane E is within the range of from about 0.5 to about 1.7.

17. The bearing unit of claim 15, wherein the relationship of the mean radius R₁ of the bearing element parallel to the plane E to the mean radius of the curvature R₂ of the balls-shaped outer surface of the bearing element transverse to the plane E is about 0.9.

18. The bearing unit of claim 15, wherein the force transmitted from the first engagement region deforms the bearing element such that the cross-section of the bearing element is drop-shaped in the plane E.

19. The bearing unit of claim 18, wherein the first engagement region is deformed elastically by the force applied by the fixing element and transmitted from the second engagement region so that when the fixing element is released, the first engagement region returns to a position in which the bearing element is not fixed to the holding element.

20. The bearing unit of claim 8, wherein the second recesses at the bearing element follow a circle-segment-shaped path running parallel to the plane E and concentric to the first recess.

21. The bearing unit of claim 10, wherein the bearing element at the first engagement region of the holding element is positively secured against displacement transverse to the plane E, relative to the holding element.

22. The bearing unit of claim 10, wherein the bearing element is ball-shaped at a position outer surface located transversely relative to plane E, which at least over a certain area positively engages a concave shape of the first engagement region.

23. The bearing unit of claim 22, wherein the relationship of a mean radius R₁ of the bearing element parallel to the plane E to a mean radius of curvature R₂ of the ball-shaped outer surface of the bearing element transverse to the plane E is within the range of about 0.2 to about 2.

24. The bearing unit of claim 23, wherein the relationship of the mean radius R₁ of the bearing element parallel to the plane E to the mean radius of the curvature R₂ of the balls-shaped outer surface of the bearing element transverse to the plane E is within the range of from about 0.5 to about 1.7.

25. The bearing unit of claim 24, wherein the relationship of the mean radius R₁ of the bearing element parallel to the plane E to the mean radius of the curvature R₂ of the balls-shaped outer surface of the bearing element transverse to the plane E is about 0.9.

26. The bearing unit of claim 10, wherein the force transmitted from the first engagement region deforms the bearing element such that the cross-section of the bearing element is drop-shaped in the plane E.

27. The bearing unit of claim 10, wherein the first engagement region is deformed elastically by the force applied by the fixing element and transmitted from the second engagement region so that when the fixing element is released, the first engagement region returns to a position in which the bearing element is not fixed to the holding element.
